(19) United States
(12) Patent Application Publication
(10) Pub. No.: US 2025/0134293 A1
(43) Pub. Date: May 1, 2025

(54) System and Method for non-face-to-face storing a commodity in the absence of a user

(71) Applicant: Hyunwoo Kim, Cambridge, MA (US)

(72) Inventor: Hyunwoo Kim, Cambridge, MA (US)

(21) Appl. No.: 18/909,771

(22) Filed: Oct. 8, 2024

(30) Foreign Application Priority Data
Oct. 26, 2023 (KR) 10-2023-0144853

(51) Int. Cl. A47G 29/30; F25D 13/04

(52) U.S. Cl. CPC A47G 29/30; F25D 13/04; F25D 2700/06

(57) ABSTRACT

A system and method for non-face-to-face storing a commodity are provided. The system for non-face-to-face storing a commodity according to one embodiment of the present invention comprises: a server; a freezer with an openable door, configured to maintain the inside at a first temperature; a refrigerator with an openable door, configured to maintain the inside at a second temperature; a storage box with an openable a door, the storage box being different from the freezer and the refrigerator; a scanner configured to identify a commodity that a delivery person delivers to a user; an identifier configured to verify that at least one of a delivery person identification code of the delivery person and a user identification code of the user has been identified; a communicator configured to communicate with the server; and a controller configured to control the opening and closing of the door of the freezer, the door of the refrigerator, and the door of the storage box.

### RELATED APPLICATIONS

This application claims priority to Korean Patent Application No. 10-2023-014485, filed on Oct. 26, 2023, the disclosure of which each is incorporated herein in its entirety by reference.

### TECHNICAL FIELD

The present invention relates to a system and method for storing a commodity in the absence of a user or in the non-face-to-face manner. According to the system and method, a delivery person is able to deliver a commodity to a user in the non-face-to-face manner, and the user is able to return a commodity in the absence or in the non-face-to-face manner.

### BACKGROUND ART

There are cases where unmanned commodity storage lockers are installed in residential buildings such as houses and apartments, and commercial buildings. Since existing storage lockers are provided with no separate temperature control device, if a delivered commodity is food that requires freezing or refrigeration, the delivered commodity is sometimes damaged.

In addition, the existing commodity storage lockers are used only when a user receives a commodity from a delivery person, and are not used for the return purpose. So, there is a problem that if the user wants to return the commodity, the commodity should be returned in the face-to-face manner, through a convenience store, a post office, or the like.

Furthermore, the existing storage lockers do not require separate verification for the identity of a delivery person when the delivery person delivers a commodity. In other words, the door of the locker is opened without the verification for the identity of the delivery person. Accordingly, there is a risk of theft of the commodity if the system incorrectly determines that the storage locker is empty because there is a commodity which is not sensed by a sensor inside the commodity storage locker. Also, there is another problem that an electronic device is exposed to unspecified persons when the electronic device such as a sensor is present inside the commodity storage locker.

### DETAILED DESCRIPTION OF THE INVENTION

### Technical Task

The object of the present invention is to solve the aforementioned problems. Specifically, the object of the present invention is to prevent a delivered commodity from being damaged even when the delivered commodity is food that requires freezing or refrigeration, and to make it possible to return a commodity in the non-face-to-face manner. Furthermore, one another object of the present invention is to increase the security for commodity storage lockers.

### Means for Achieving the Task

To achieve the aforementioned technical objects, the system for non-face-to-face storing a commodity according to one embodiment of the present invention comprises: a server; a freezer with an openable door, configured to maintain the inside at a first temperature; a refrigerator with an openable door, configured to maintain the inside at a second temperature; a storage box with an openable a door, the storage box being different from the freezer and the refrigerator; a scanner configured to identify a commodity that a delivery person delivers to a user; an identifier configured to verify that at least one of a delivery person identification code of the delivery person and a user identification code of the user has been identified; a communicator configured to communicate with the server; and a controller configured to control the opening and closing of the door of the freezer, the door of the refrigerator, and the door of the storage box, wherein when the scanner identifies the commodity, the communicator transmits information on the commodity to the server; based at least in part on the verification by the identifier that at least one of the delivery person identification code and the user identification code has been identified, the controller opens the door of at least one of the freezer, the refrigerator and the storage box; the controller transmits, to the server, information on the opening and closing of the door of at least one of the freezer, the refrigerator and the storage box, by means of the communicator; and the server calculates cost information on at least one of the delivery person and the user, based at least in part on the opening and closing information.

The controller may open the door of at least one of the freezer, the refrigerator and the storage box, further based on whether the information of the commodity identified by the scanner matches the given commodity information.

The system for non-face-to-face storing a commodity may further comprise a first camera configured to photograph the exterior of the freezer, the refrigerator and the storage box; and a second camera configured to photograph the interior of at least one of the freezer, the refrigerator and the storage box, wherein the communicator may transmit, to the server, data photographed by the first camera and the second camera.

When the identifier verifies that the delivery person identification code has been identified, the communicator may transmit, to the server, at least one of time when the delivery person identification code is identified and the delivery person identification code.

The scanner may also identify a returned commodity that the user returns to a collector; the identifier may also verify that a collector identification code of the collector has been identified; when the scanner identifies the returned commodity, the communicator may transmit information of the returned commodity to the server; and based at least in part on the verification by the identifier that the collector identification code has been identified, the controller may open the door of the freezer, the refrigerator and the storage box where the returned commodity is stored.

The method for non-face-to-face storing a commodity according to one embodiment of the present invention comprises: identifying a commodity by the scanner; transmitting, by the communicator, information on the commodity to the server; verifying, by the identifier, that at least one of the delivery person identification code and the user identification code has been identified; based at least in part on the verification by the identifier that at least one of the delivery person identification code and the user identification code has been identified, opening, by the controller, the door of at least one of the freezer, the refrigerator and the storage box; transmitting, by the controller to the server, the opening and closing information of the door of at least one of the freezer, the refrigerator and the storage box, by means of the communicator; and calculating, by the server, cost information on at least one of the delivery person and the user, based at least in part on the opening and closing information.

The step of opening, by the controller, the door of at least one of the freezer, the refrigerator and the storage box may be further based on whether the information of the commodity identified by the scanner matches the given commodity information.

The system for non-face-to-face storing a commodity may further comprise a first camera configured to photograph the exterior of the freezer, the refrigerator and the storage box; and a second camera configured to photograph the interior of at least one of the freezer, the refrigerator and the storage box, and the method for non-face-to-face storing a commodity may further comprise transmitting, by the communicator to the server, data photographed by the first camera and the second camera.

The method may further comprise, when the identifier verifies that the delivery person identification code has been identified, transmitting, by the communicator to the server, at least one of time when the delivery person identification code is identified and the delivery person identification code.

The method may comprise identifying, by the scanner, a returned commodity that the user returns to a collector; verifying, by the identifier, that a collector identification code of the collector has been identified; when the scanner identifies the returned commodity, transmitting, by the communicator, information of the returned commodity to the server; and based at least in part on the verification by the identifier that the collector identification code has been identified, opening, by the controller, the door of the freezer, the refrigerator and the storage box where the returned commodity is stored.

### Effect of the Invention

According to the present invention, it is possible to prevent a delivered commodity from being damaged even when the delivered commodity is food that requires freezing or refrigeration. Also, this makes it possible to return a commodity in the non-face-to-face manner. Furthermore, the security for commodity storage lockers can be further increased.

### BRIEF DESCRIPTION OF THE DRAWINGS

FIG. 1 is a diagram illustrating one embodiment of the system for non-face-to-face storing a commodity.

FIG. 2 is a diagram illustrating the exterior of the freezer, the refrigerator and the storage box according to one embodiment.

FIG. 3 is a diagram illustrating an interior of the freezer, the refrigerator and the storage box according to one embodiment.

FIGS. 4 to 7 are diagrams illustrating an installation state of the system for non-face-to-face storing a commodity according to the embodiment.

### DETAILED DESCRIPTION FOR CARRYING OUT THE INVENTION

Hereinafter, the preferred embodiments of the present invention will be described in detail with reference to the accompanying drawings. Advantages and features of the present invention and methods for achieving the same will become apparent with reference to the embodiments described in detail below together with the accompanying drawings. However, the present invention is not limited to the embodiments described below, but may be implemented in various different manners, and the embodiments of the present invention are provided so as to complete the disclosure of the present invention and to completely inform a person having ordinary skill in the art to which the present invention pertains of the scope of the present invention, and the present invention is defined only by the scope of the claims. The same reference numerals refer to the same components throughout the specification.

Unless otherwise defined, all terms (including technical and scientific terms) used in the present specification have the same meaning as commonly understood by a person having ordinary skill in the art to which the present invention pertains. In addition, terms defined in commonly used dictionaries are not interpreted ideally or excessively unless they are clearly specifically defined.

The terms used in the present specification are to explain the embodiments and are not intended to limit the present invention. In the specification, a singular term includes a plural term unless specifically mentioned in the text. The term ‘comprise’ and/or ‘comprising’ used in the specification does not exclude the presence or addition of one or more other components in addition to the mentioned components.

Hereinafter, the system and method for non-face-to-face storing a commodity according to the embodiments of the present invention will be described with reference to the drawings.

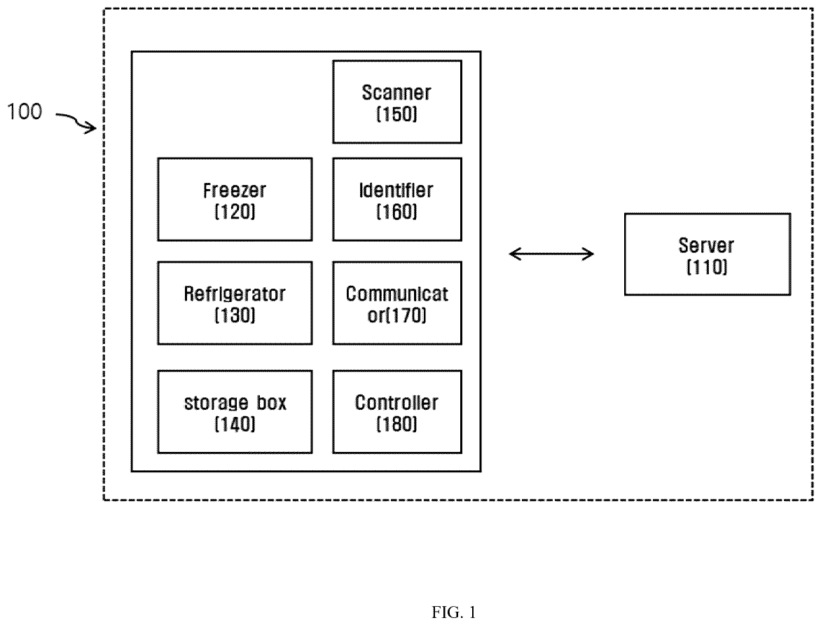

Referring to FIG. 1, the system (100) for non-face-to-face storing a commodity according to one embodiment of the present invention comprises: a server (100); a freezer (120) with an openable door, configured to maintain the inside at a first temperature; a refrigerator (120) with an openable door, configured to maintain the inside at a second temperature; a storage box (140) with an openable a door, the storage box being different from the freezer and the refrigerator; a scanner (150) configured to identify a commodity that a delivery person delivers to a user; an identifier (160) configured to verify that at least one of a delivery person identification code of the delivery person and a user identification code of the user has been identified; a communicator (170) configured to communicate with the server; and a controller (180) configured to control the opening and closing of the door of the freezer, the door of the refrigerator, and the door of the storage box, wherein when the scanner identifies the commodity, the communicator transmits information on the commodity to the server; based at least in part on the verification by the identifier that at least one of the delivery person identification code and the user identification code has been identified, the controller opens the door of at least one of the freezer, the refrigerator and the storage box; the controller transmits, to the server, information on the opening and closing of the door of at least one of the freezer, the refrigerator and the storage box, by means of the communicator; and the server calculates cost information on at least one of the delivery person and the user, based at least in part on the opening and closing information.

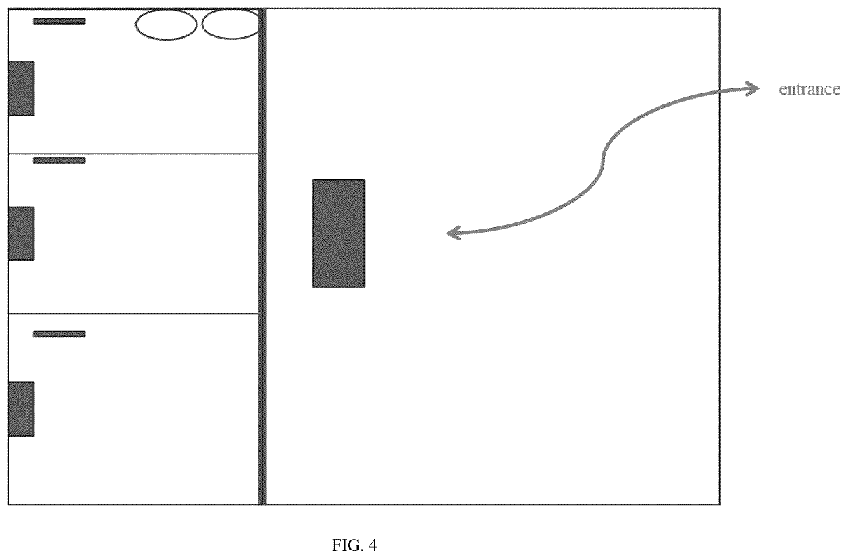

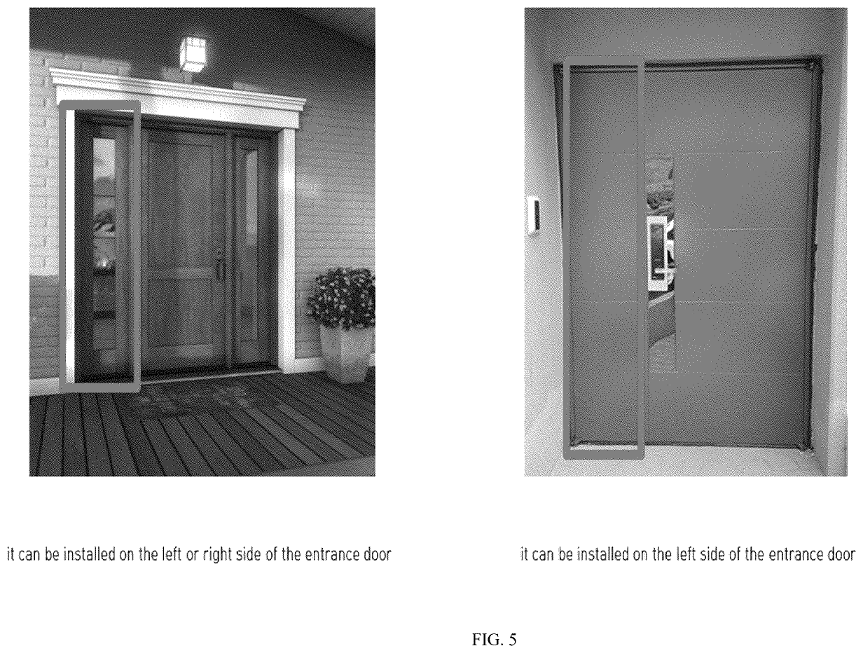

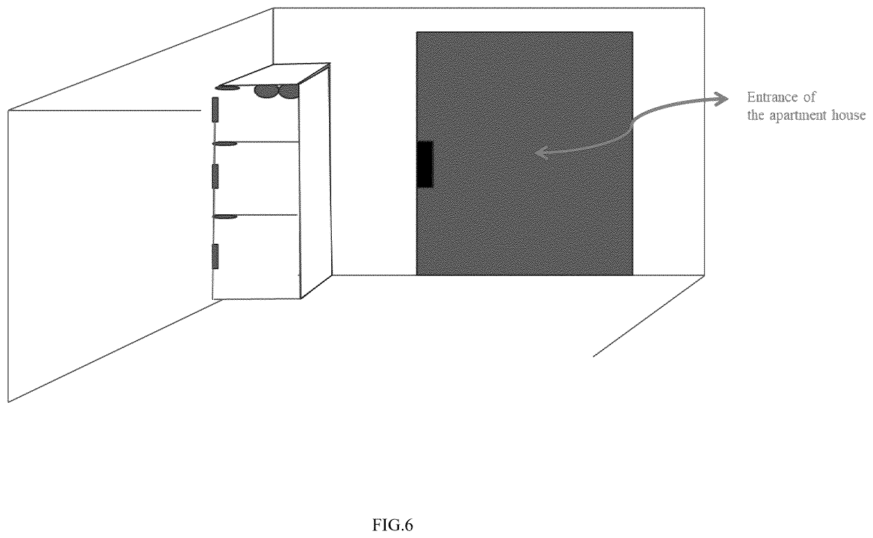

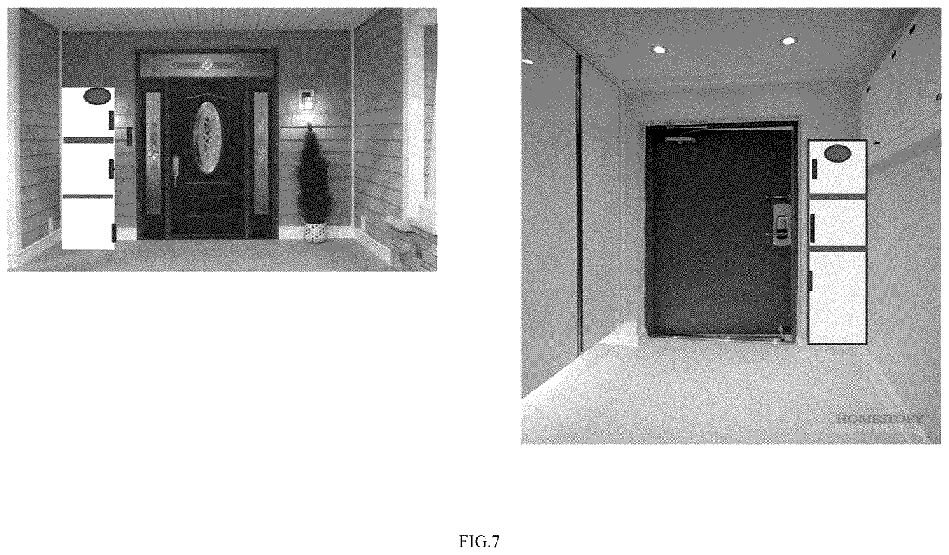

As shown in FIGS. 4 to 6, the freezer (120), the refrigerator (130), the storage box (140), the scanner (150), the identifier (160), the communicator (170), and the controller (180) of the system (100) for non-face-to-face storing a commodity may be installed near the entrance of the building. According to one embodiment, the freezer (120), the refrigerator (130), the storage box (140), the scanner (150), the identifier (160), the communicator (170), and the controller (180) of the system (100) for non-face-to-face storing a commodity may be installed within 10 m, preferably within 5 m from the entrance, preferably on the entrance. Herein, the server (110) of the system (100) for non-face-to-face storing a commodity may be located near the entrance, like the freezer (120), or may be located in a separate place. For example, the server (110) may be separately located in the building of a company that manufactures or manages the system (100) for non-face-to-face storing a commodity.

The freezer (120) has an openable door, and maintains the inside at a first temperature. The first temperature may be a temperature at which the commodity can be frozen. For example, the first temperature may be 0° C. or less. Also, the first temperature may be changed by a setting. The freezer (120) may have a temperature control device therein.

The refrigerator (130) has an openable door, and maintains the inside at a second temperature. The second temperature may be higher than the first temperature, and the second temperature may be changed by a setting. The refrigerator (130) may have a temperature control device therein.

The storage box (140) has an openable door, and is a separate storage box different from the freezer and the refrigerator. The storage box (140) may or may not have a temperature control device therein.

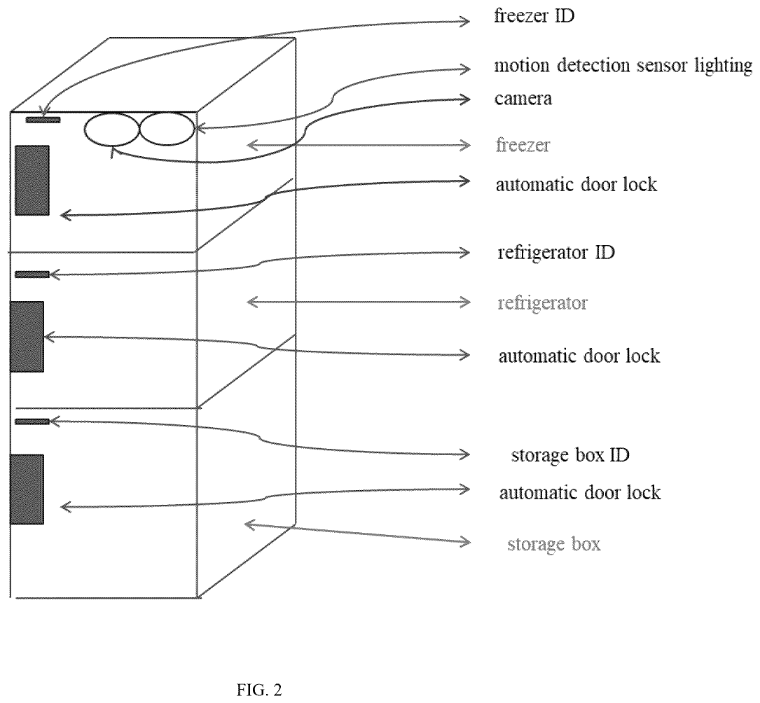

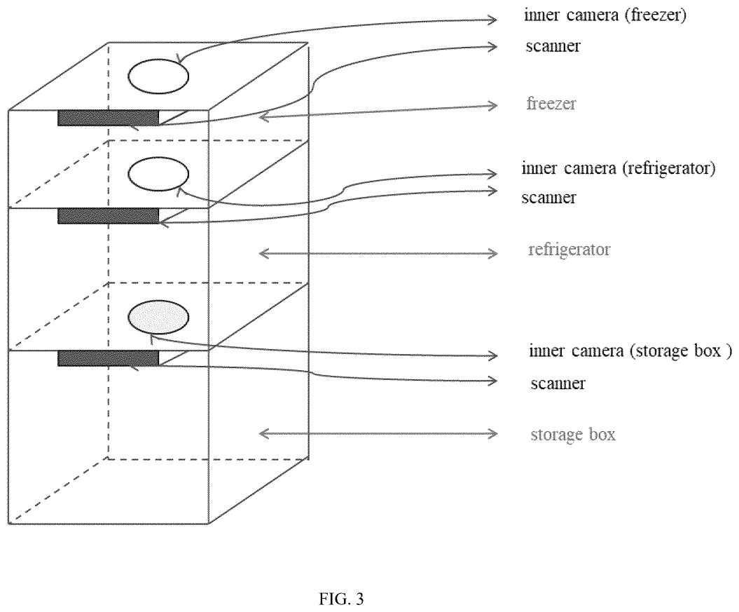

As shown in FIG. 2, the freezer, the refrigerator and the storage box may have respective separate IDs. In addition, the system for non-face-to-face storing a commodity according to one embodiment may further comprise a motion detection sensor lighting installed outside the freezer, the refrigerator and the storage box. For example, when the user has approached the freezer, etc. at night, this senses this and lights on, which makes it facilitate to photograph by the camera. Further, the system for non-face-to-face storing a commodity according to one embodiment may further comprise a first camera configured to photograph the exterior of the freezer, the refrigerator and the storage box. Moreover, as shown in FIG. 3, the system for non-face-to-face storing a commodity according to one embodiment may further comprise a second camera configured to photograph the interior of at least one of the freezer, the refrigerator and the storage box. Here, the communicator (170) configured to communicated with the server (110) may transmit, to the server (110), data photographed by the first camera or the second camera. The photographed data may include a picture, an image, a voice, and the like.

The scanner (150) identifies the commodity that the delivery person delivers to the user. According to one embodiment, the scanner (150) may scan a barcode, a QR code, a paragraph, or the like to acquire information of the commodity. The information of the commodity may include at least one of a name, a place of sale, a unique number, a date of manufacture, a price, a type, a delivery place, a recipient, a sender, and the like, of the commodity. As shown in FIG. 3, the scanner may be located inside or outside the freezer, the refrigerator and the storage box. When the scanner identifies the commodity, the communicator transmits information on the commodity to the server.

The identifier (160) verifies that at least one of the delivery person identification code of the delivery person and the user identification code of the user has been identified. When the delivery person attempts to open a commodity storage locker (freezer, refrigerator, storage box), the identifier verifies that the delivery person identification code of the delivery person has been identified. On the other hand, when the user attempts to open the commodity storage locker, the identifier verifies that the user identification code of the user has been identified. According to one embodiment, the identifier may receive an input of the delivery person identification code directly from the delivery person. According to another embodiment, when the delivery person inputs the delivery person identification code into an application installed in a separate device (e.g., a delivery person's smartphone, a PDA, etc.), the server (110) may confirm the input of the delivery person identification code, and then the server (110) may inform the identifier (160) of the fact that the delivery person identification code has been correctly input, through a message or the like. This is applied also for the user identification code.

The delivery person identification code or the user identification code may or may not be a one-time code. In addition, the delivery person identification code or the user identification code may be previously registered biometric information. Further, the delivery person identification code or the user identification code may be a barcode, a QR code, a character, a number, or a combination thereof, and the form is not limited.

The order of the step of identifying the commodity by the scanner (150) and the step of verifying, by the identifier (160), that at least one of the delivery person identification code and the user identification code has been identified is not defined. Specifically, the step of verifying, by the identifier (160), that at least one of the delivery person identification code and the user identification code has been identified may be performed after the step of identifying the commodity by the scanner (150), or vice versa.

When the identifier (160) verifies that the delivery person identification code has been identified, the communicator (170) may transmit, to the server (110), at least one of time when the delivery person identification code is identified and the delivery person identification code. In this case, the server (110) may inform the user of the information on the delivery. For example, the server may transmit a message including information on the delivery person, information on delivery completion time, and the like, to the device of the user. Or, the server may display information on the delivery person, information on delivery completion time, and the like, in an application installed in the device of the user. In this case, the information on the delivery person may include a name of the delivery person, an identification code of the delivery person, a nickname of the delivery person, and the like.

The communicator (170) may transmit, to the server (110), information on time when the refrigerator, the freezer or the storage box is opened or closed. In this case, the server (110) may inform the user of information on time when the refrigerator, the freezer or the storage box is opened or closed.

The controller (180) controls opening and closing of the door of the freezer, the door of the refrigerator, and the door of the storage box. The controller opens the door of at least one of the freezer, the refrigerator and the storage box, based at least in part on the verification by the identifier that at least one of the delivery person identification code and the user identification code has been identified. According to one embodiment, the controller may open the door of at least one of the freezer, the refrigerator and the storage box, further based on whether the information of the commodity identified by the scanner matches the given commodity information. Specifically, when the delivery person delivers a commodity, even if it is verified that the delivery person identification code has been identified, if information on the commodity identified by the scanner does not match information on the commodity previously received from the server, the controller may not open the freezer, the refrigerator and the storage box. Thereby, the security of the commodity storage system may be further increased.

According to one embodiment, the system for non-face-to-face storing a commodity may receive, from the delivery person, information on which of the freezer, the refrigerator and the storage box is to be opened, and then, the controller may open the selected storage locker. According to another embodiment, the controller may determine which of the freezer, the refrigerator and the storage box is to be opened, based on the information on the delivered commodity. Specifically, the system for non-face-to-face storing a commodity may determine the storage locker where the delivered commodity is to be stored, based on information on the delivered commodity by the scanner or information on the delivered commodity transferred from the server. Specifically, when information indicating that the delivered commodity (for example, fish) requires freezing is recorded and the scanner identifies the information, the controller may control to open the freezer. Alternatively, the controller may receive, from the server, information indicating that the delivered commodity requires freezing, and then, control to open the freezer.

The controller (180) may transmit, to the server, information on opening and closing of at least one of the door of the freezer, the refrigerator, and the storage box, by means of the communicator. In this case, the opening and closing information may include an opening and closing time, whether the door is opened or closed, the number of times of opening and closing, whether any door among storage boxes is opened or closed, and the like.

The server (110) calculates cost information on at least one of the delivery person and the user, based at least in part on the opening and closing information. For example, whenever the door of the commodity storage locker (freezer, refrigerator, storage box) is opened, the server may charge the delivery person or the user for a fee. In this case, the method of charging the fee may be charging the fees later or reducing the charged amount, and there is no limitation. According to one embodiment, the server may also charge a delivery person or a user for the fees for the issuance of the delivery person identification code or the user identification code.

The system (100) for non-face-to-face storing a commodity may also be used for return of a commodity. Specifically, if the user puts a returned commodity in at least one of the freezer, the refrigerator and the storage box of the system for non-face-to-face storing a commodity, the collector may collect the returned commodity later. In this case, the user may input, into the system for non-face-to-face storing a commodity, information on which of the freezer, the refrigerator and the storage box the returned commodity is to be put. According to one embodiment, the input may be performed by a separate device comprised in the system for non-face-to-face storing a commodity. Alternatively, the user may directly transmit the information to the server (110), through an application installed in the device possessed by the user. According to one embodiment, the scanner (150) may also identify the returned commodity that the user returns to the collector, and the identifier (160) may also verify that the collector identification code of the collector has been identified. In this case, when the scanner identifies the returned commodity, the communicator transmits information of the returned commodity to the server. Also, the controller may open the door of the freezer, the refrigerator and the storage box where the returned commodity is stored, based at least in part on the verification by the identifier that the collector identification code has been identified.

The embodiments of the present invention are explained above with reference to the accompanying drawings, but it will be understood by those skilled in the art that the present invention can be implemented in other specific forms without changing the technical idea or essential feature. It should be noted, therefore, that the embodiments described above are exemplary and not limited in all aspects.

### EXPLANATIONS FOR REFERENCE NUMERALS

100: System for non-face-to-face storing a commodity
110: Sever
120: Freezer
130: Refrigerator
140: Storage box
150: Scanner
160: Identifier
170: Communicator
180: Controller

1. A system for non-face-to-face storing a commodity, comprising:
a server;
a freezer with an openable door, configured to maintain the inside at a first temperature;
a refrigerator with an openable door, configured to maintain the inside at a second temperature;
a storage box with an openable a door, the storage box being different from the freezer and the refrigerator;
a scanner configured to identify a commodity that a delivery person delivers to a user;
an identifier configured to verify that at least one of a delivery person identification code of the delivery person and a user identification code of the user has been identified;
a communicator configured to communicate with the server; and
a controller configured to control the opening and closing of the door of the freezer, the door of the refrigerator, and the door of the storage box,
wherein when the scanner identifies the commodity, the communicator transmits information on the commodity to the server;
based at least in part on the verification by the identifier that at least one of the delivery person identification code and the user identification code has been identified, the controller opens the door of at least one of the freezer, the refrigerator and the storage box;
the controller transmits, to the server, information on the opening and closing of the door of at least one of the freezer, the refrigerator and the storage box, by means of the communicator; and
the server calculates cost information on at least one of the delivery person and the user, based at least in part on the opening and closing information.

2. The system for non-face-to-face storing a commodity according to claim 1, wherein the controller may open the door of at least one of the freezer, the refrigerator and the storage box, further based on whether the information of the commodity identified by the scanner matches the given commodity information.

3. The system for non-face-to-face storing a commodity according to claim 1, wherein the system further comprises a first camera configured to photograph the exterior of the freezer, the refrigerator and the storage box; and a second camera configured to photograph the interior of at least one of the freezer, the refrigerator and the storage box, wherein the communicator transmits, to the server, data photographed by the first camera and the second camera.

4. The system for non-face-to-face storing a commodity according to claim 1, wherein when the identifier verifies that the delivery person identification code has been identified, the communicator transmits, to the server, at least one of time when the delivery person identification code is identified and the delivery person identification code.

5. The system for non-face-to-face storing a commodity according to claim 1, wherein the scanner identifies a returned commodity that the user returns to a collector;
the identifier verifies that a collector identification code of the collector has been identified;
when the scanner identifies the returned commodity, the communicator transmits information of the returned commodity to the server; and
based at least in part on the verification by the identifier that the collector identification code has been identified, the controller opens the door of the freezer, the refrigerator and the storage box where the returned commodity is stored.

6. A method for non-face-to-face storing a commodity, performed by the system for non-face-to-face storing a commodity,
the system for non-face-to-face storing a commodity comprising:
a server;
a freezer with an openable door, configured to maintain the inside at a first temperature;
a refrigerator with an openable door, configured to maintain the inside at a second temperature;
a storage box with an openable a door, the storage box being different from the freezer and the refrigerator;
a scanner configured to identify a commodity that a delivery person delivers to a user;
an identifier configured to verify that at least one of a delivery person identification code of the delivery person and a user identification code of the user has been identified;
a communicator configured to communicate with the server; and
a controller configured to control the opening and closing of the door of the freezer, the door of the refrigerator, and the door of the storage box, and
the method for non-face-to-face storing a commodity comprising:
identifying a commodity by the scanner;
transmitting, by the communicator, information on the commodity to the server;
verifying, by the identifier, that at least one of the delivery person identification code and the user identification code has been identified;
based at least in part on the verification by the identifier that at least one of the delivery person identification code and the user identification code has been identified, opening, by the controller, the door of at least one of the freezer, the refrigerator and the storage box;
transmitting, by the controller to the server, the opening and closing information of the door of at least one of the freezer, the refrigerator and the storage box, by means of the communicator; and
calculating, by the server, cost information on at least one of the delivery person and the user, based at least in part on the opening and closing information.

7. The method for non-face-to-face storing a commodity according to claim 6, wherein the step of opening, by the controller, the door of at least one of the freezer, the refrigerator and the storage box is further based on whether the information of the commodity identified by the scanner matches the given commodity information.

8. The method for non-face-to-face storing a commodity according to claim 6, wherein the system for non-face-to-face storing a commodity further comprises a first camera configured to photograph the exterior of the freezer, the refrigerator and the storage box; and a second camera configured to photograph the interior of at least one of the freezer, the refrigerator and the storage box; and
the method for non-face-to-face storing a commodity further comprises transmitting, by the communicator to the server, data photographed by the first camera and the second camera.

9. The method for non-face-to-face storing a commodity according to claim 6, wherein the method further comprises, when the identifier verifies that the delivery person identification code has been identified, transmitting, by the communicator to the server, at least one of time when the delivery person identification code is identified and the delivery person identification code.

10. The method for non-face-to-face storing a commodity according to claim 6, wherein the method comprises:
identifying, by the scanner, a returned commodity that the user returns to a collector;
verifying, by the identifier, that a collector identification code of the collector has been identified;
when the scanner identifies the returned commodity, transmitting, by the communicator, information of the returned commodity to the server; and
based at least in part on the verification by the identifier that the collector identification code has been identified, opening, by the controller, the door of the freezer, the refrigerator and the storage box where the returned commodity is stored.
